(19) United States
(12) Patent Application Publication
(10) Pub. No.: US 2005/0011146 A1
(43) Pub. Date: Jan. 20, 2005

(54) Household safe window

(76) Inventor: Yun-Chu Lee, Taipei (TW)

Correspondence Address: YUN-CHU LEE, P.O. BOX 26-757, TAIPEI, 106, TW

(21) Appl. No.: 10/886,379

(22) Filed: Jul. 8, 2004

(30) Foreign Application Priority Data
Jul. 14, 2003 (CN) 03275704.2

(51) Int. Cl. E06B 3/00

(52) U.S. Cl. 52/204.1; 52/204.5

(57) ABSTRACT

This invention describes a household safe window, which has a fixed window frame, a large sash, a small sash, and a first and second linking member. The fixed window frame is embedded in a pre-formed frame. The opposite sides of the large sash, via the first linking member, are pivotally fitted into the fixed window frame, thereby enabling the large sash to open along the right or left side. The large sash is formed as a carved-through frame, which can receive the small sash. A first pivoting member is provided on the large sash, which is used to pivotally interconnect with a second pivoting member of the small sash, thereby enabling the second link member to connect with the opposite sides of the small sash to drive the window to swing up and down.

### BACKGROUND OF THE INVENTION

1. Field of the Invention

This invention refers to a household safe window, and more particularly to an innovative household window capable of awning-type operation (swinging up and down) and casement-type operation (opening and closing along the right or left side).

2. Description of the Prior Art

Generally, the windows used in a room or building are of awning-type (swinging up and down) or casement-type (opening and closing along the right or left side).

Referring to FIG. 1, a cross-sectional diagram of a conventional aluminum awning-type window is shown, which comprises a push-out sash 10 and a fixed window frame 11. The push-out sash 10 and fixed window sash 11 may be an aluminum extruded window frame. The fixed window frame 11 is embedded in a pre-formed frame on the wall (not shown). A linking member 112 is formed inside the fixed window frame 11, which is pivotally connected into opposite sides of the push-out sash 10, thereby enabling the push-out sash 10 to be pushed and pulled to swing up or down.

Referring to FIG. 2, a cross-sectional diagram of a conventional aluminum casement-type window is shown, which comprises a push-out sash 10a and a fixed window frame 11a. The push-out sash 10a and a fixed window frame 11a may be an aluminum extruded window frame. The fixed window frame 11a is embedded in a pre-formed frame on the wall (not shown). A linking member 111a is connected with opposite sides of the fixed window frame 11a, which enables the push-out sash 10a to be pushed outward for opening.

However, the above-mentioned awning-type or casement-type window only has the capability of pushing the window unit to swing up and down or opening the window unit along the right or left side. The performance is not ideal in with regard to opening space, ventilation, water and security.

Therefore, there is a need to resolve the inconveniences and disadvantages encountered during the practical installation and use of the above-mentioned conventional awning-type or casement-type window.

Accordingly, a household safe window according to this invention is provided to improve the above inconveniences and disadvantages with a reasonable design.

### SUMMARY OF THE INVENTION

In order to improve the disadvantages and retain the advantages of the above-mentioned conventional windows, it is a main object of this invention to provide a household safe window having a large sash carved through to receive a small sash, with the use of first and second linking members to achieve the actions of pushing the window unit to swing up and down or opening the window unit along the right or left side, thereby increasing the convenience of using the window.

In order to achieve the above object, it is a main feature of this invention to provide a household safe window, which comprises a fixed window frame, a large sash, a small sash, and a first and second linking member. The large sash, via the first linking member, is pivotally fitted into the fixed window frame embedded in the wall. The large sash is coupled with the first linking member at opposite sides thereof, and the first linking member is adapted to enable the large sash to operate the action of opening along the right or left side. The large sash is formed as a carved-through frame, so as to receive the small sash. The large sash is provided with a first pivoting member, which is used to pivotally interconnect with a second pivoting member of the small sash, thereby enabling the second link member connected with the opposite sides of the small sash to drive the window to swing up and down.

With reference to the accompanying drawings, the features and technical contents of the present invention will become apparent from the detailed description of the present invention. However, those accompanying drawings are merely for reference and illustrative purpose, and are not intended to limit the scope of the invention.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a cross-sectional diagram of a conventional awning-type aluminum window;

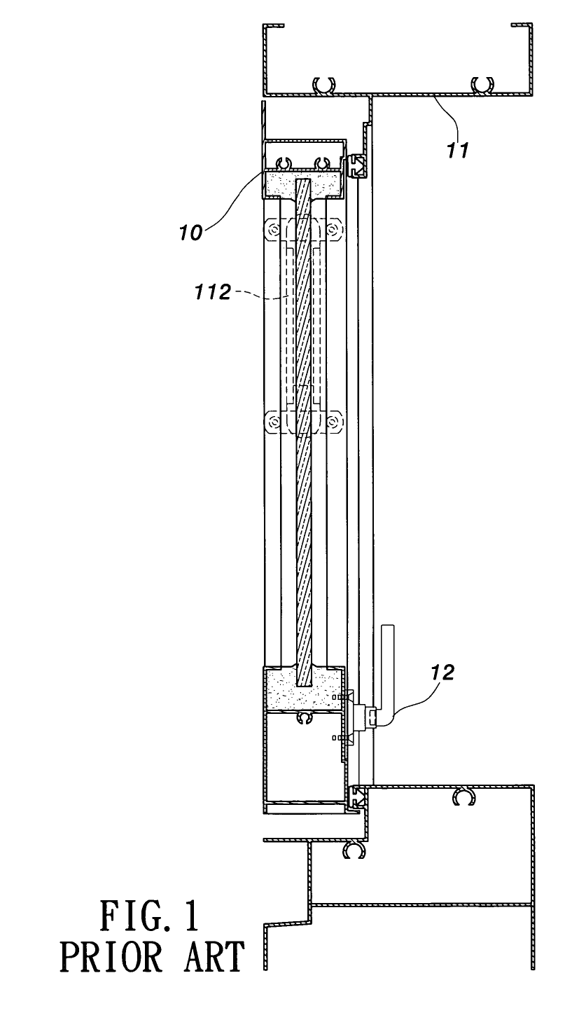

FIG. 2 is a cross-sectional diagram of a conventional casement-type aluminum window;

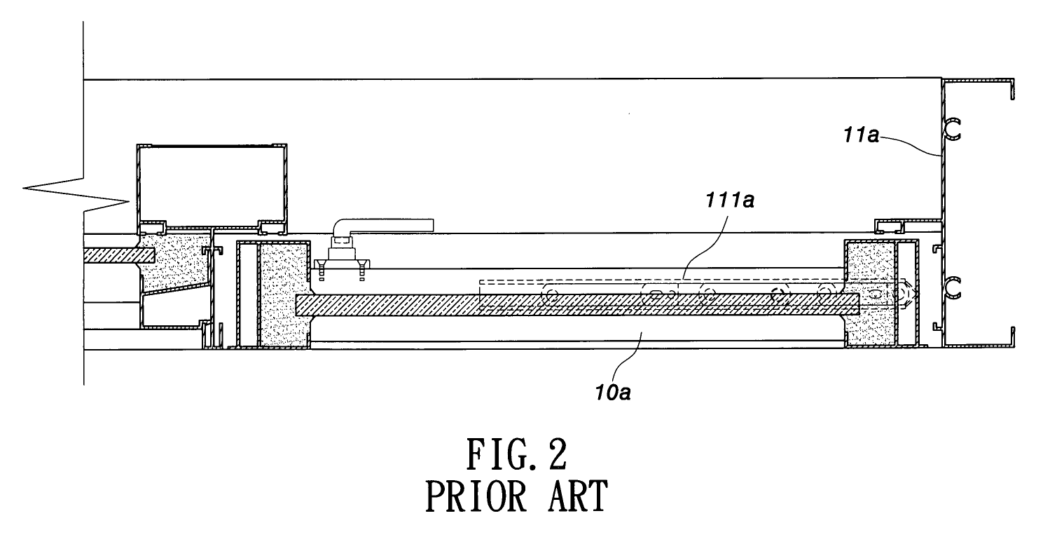

FIG. 3 is a block diagram of a household window according to this invention;

FIG. 4 is a cross-sectional assembly diagram of the household window according to this invention;

FIG. 5 is an operational diagram viewed from the side of a large sash according to this invention;

FIG. 6 is a cross-sectional assembly diagram of a small sash according to this invention;

FIG. 7 is an operational diagram viewed from the side of a small sash according to this invention being in use; and

FIG. 8 is a cross-sectional diagram of another embodiment according to this invention shown.

### DETAILED DESCRIPTION OF PREFERRED EMBODIMENTS

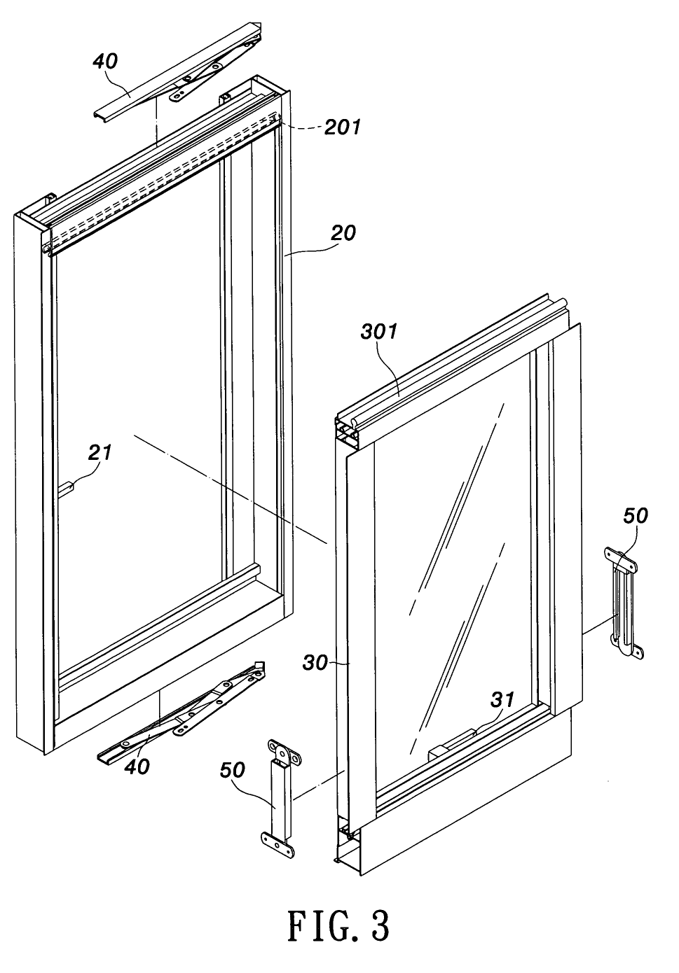

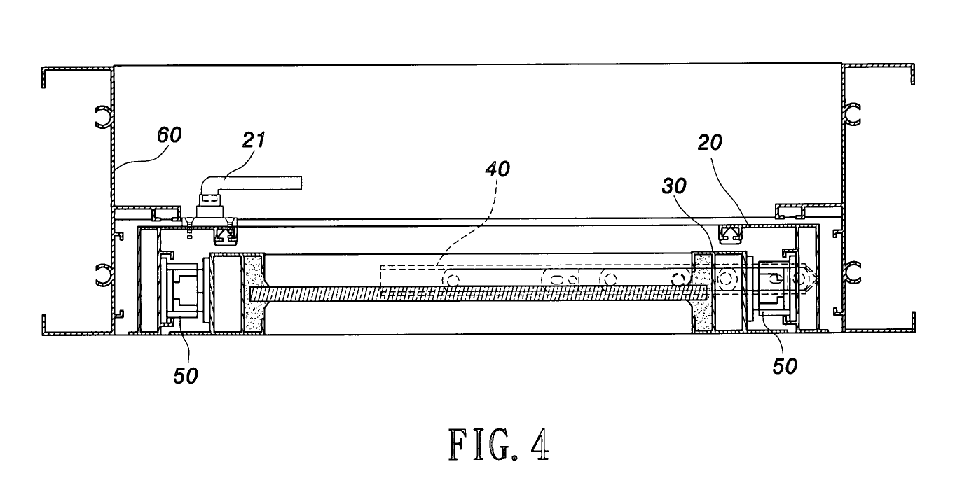

Referring to FIGS. 3 and 4, this invention provides a household safe window, and more particularly an innovative household window capable of awning-type operation (swinging up and down) and casement-type operation (opening and closing along the right or left side). The household safe window comprises a fixed window frame 60, a large sash 20, a small sash 30, and first and second linking members 40, 50.

The large sash 20, via the first linking member 40, is pivotally fitted into the fixed window frame 60. The first linking member 40 may be a member such as a connecting rod or hinge.

The fixed window frame 60 is embedded in a pre-formed frame on the wall (not shown), thereby enabling the large sash 20 to open and close along the right or left side via the first linking member 40 connected at opposite sides thereof. Since the above-mentioned structure is similar to that of the prior art and does not fall within the scope of this invention, the detailed description for its structure and connecting manner is omitted.

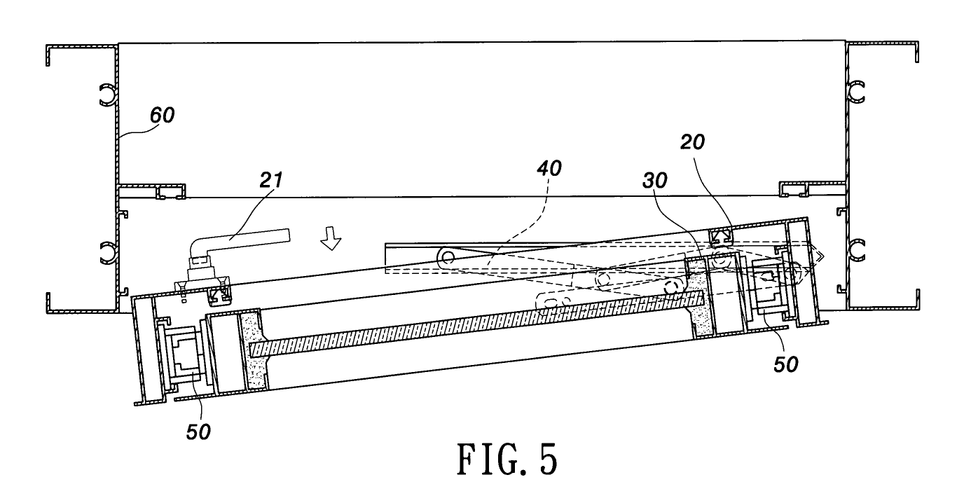

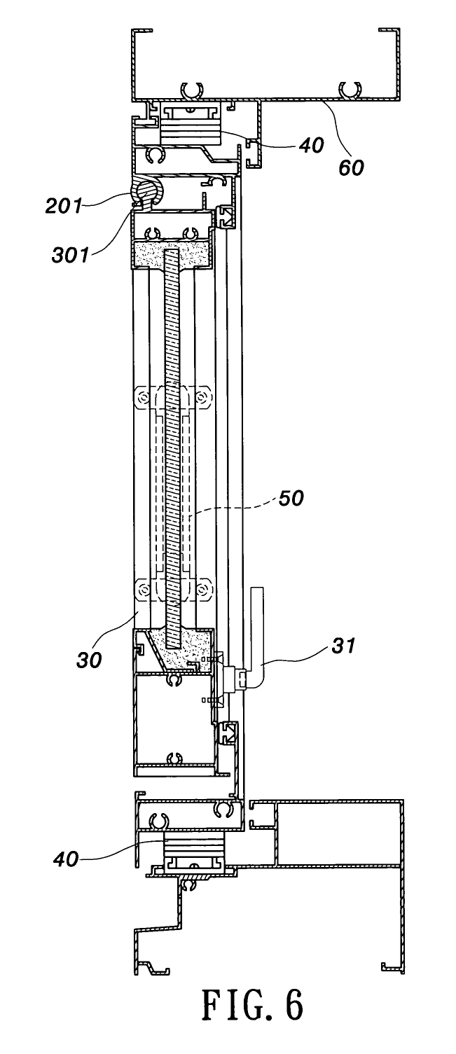

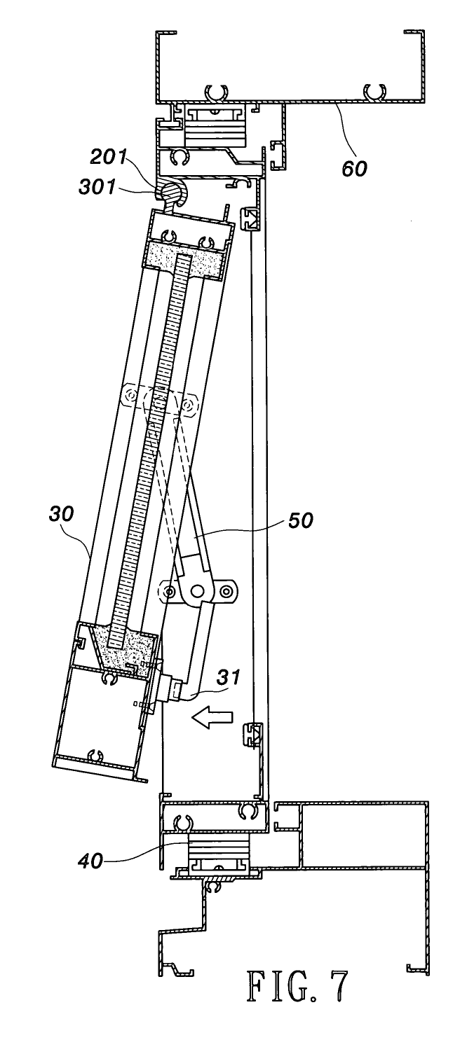

Referring to FIGS. 3-7, in this invention, the large sash 20 is formed as a carved-through frame, which is slightly larger than the frame of the small sash 30, thus enabling the small sash 30 to fit inside the same. The large sash 20 is provided with a first pivoting member 201 (shown in FIG. 6). The first pivoting member 201 is used to interconnect pivotally with a second pivoting member 301 of the small sash 30, thereby enabling the user to swing the window up and down via the second link member 50 with a connecting rod or hinge connected with the opposite sides of the small sash 30 to cause the window to swing up and down.

Furthermore, a first locking unit 21 is provided between the large sash 20 and the fixed window frame 60 (shown in FIG. 4). A second locking unit 31 is provided between the large sash 20 and the small sash 30 (shown in FIG. 6). The first and second locking units 21, 31 facilitate opening and locking either the large sash 20 or the small sash 30, thereby acting preventing burglary and other risk situations while maintaining good ventilation in the room.

Moreover, the glass of the small sash 30 swinging up can be used as a rain shelter.

Additionally, in order to make the structure compact and seamless when the large sash 20, the small sash 30 and the fixed window frame 60 are folded together, a soft cushion (such as a spongy cushion) is provided on the contact surfaces between the fixed window frame 60, the large sash 20 and the small sash 30 (not shown).

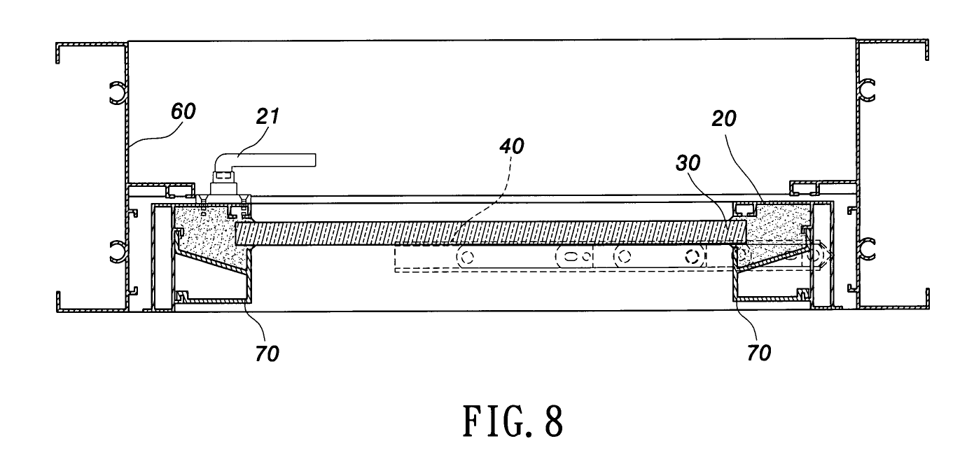

Referring to FIG. 8, a cross-sectional diagram of another embodiment according this invention is shown. Optionally, a set of retaining plates 70 is provided inside the carved-through large sash 20. Subsequently, a glass is held thereon, so as to implement only an awning-type aluminum window (swinging up and down) or a casement-type aluminum window (opening and closing along the right or left side). Furthermore, other options for fully implementing the application are possible and there is not a need to remove or replace the fixed frame 60.

The large sash 20 according to this invention is carved through to receive the small sash 30, together with the first pivoting member 201, the second pivoting member 301, and the first and second linking members 40, 50 to form a household window capable of opening the window by swinging up and down and along the right or left side. The advantages of the prior art are inherited, and there are other advantages impossible for the prior art.

Although possible embodiments of the invention have been described above, it is to be understood that the scope of the invention is not limited to these embodiments; in the same way, all equivalent structures and modifications as implemented in this specification and as illustrated in these drawings, or as directly or indirectly applied in other relevant fields are covered within the scope of this invention.

1. A household safe window, comprising:
a fixed window frame embedded in a pre-formed frame on a wall;
a large sash formed as a carved-through frame, wherein a first pivoting member is provided at opposite sides of the large sash, thereby enabling the large sash to connect with the fixed window frame;
a small sash received inside the large sash, wherein a second linking member is connected with opposite sides of the small sash, thereby enabling the first and second link members to drive the window to swing up and down and open the window along the right or left side.

2. The household safe window according to claim 1, wherein a soft cushion is provided on the contact surface between the fixed window frame, the large sash and the small sash.

3. The household safe window according to claim 1, wherein a first locking unit is provided between the fixed window frame and the large sash.

4. The household safe window according to claim 1, wherein a first pivoting member is provided on the large sash, a second pivoting member is provided on the small sash, and the first pivoting member is pivotally interconnected with the second pivoting member.

5. The household safe window according to claim 1, wherein the first linking member of the large sash and the second linking member of the small sash are connecting rods or hinges.

6. The household safe window according to claim 1, wherein a second locking unit is provided between the large sash and the small sash.

7. The household safe window according to claim 1, wherein a retaining plate is provided inside the large sash.
